(19) United States
(12) Patent Application Publication
(10) Pub. No.: US 2002/0184819 A1
(43) Pub. Date: Dec. 12, 2002

(54) Undergroud root cultivating irrigating device

(76) Inventor: Min-Yen Huang, Tainan (TW)

Correspondence Address: David E. Dougherty, DENNISON, SCHULTZ & DOUGHERTY, 612 CRYSTAL SQUARE 4, 1745 JEFFERSON DAVIS HIGHWAY, ARLINGTON, VA, 22202, US

(21) Appl. No.: 09/876,039

(22) Filed: Jun. 8, 2001

(51) Int. Cl. A01G 29/00

(52) U.S. Cl. 47/48.5

(57) ABSTRACT

An underground root cultivating irrigating device by siphon principle is disclosed. The device is embedded underground. The device comprises a vacuum water tank, a switch, and a water supply tank and other components. The level of inlet water is controlled by the buoyancy of a lifting pontoon. By the punching force of a collision pontoon, the opening and closing of a switch stud so that water may be supplied automatically. By the siphon principle of atmosphere, water supplies to the water supply tank is controlled automatically. Then, according to the wetness of earth, the drainage speed of water is adjusted, so that the irrigating is performed with less power and time.

### BACKGROUND OF THE INVENTION

The present invention relates to underground root cultivating irrigating device, wherein by the siphon principle of atmosphere, water supplies to the water supply tank is controlled automatically. Then, according to the wetness of earth, the drainage speed of water is adjusted, so that the irrigating is performed with less power and time.

In the irrigating, water and fertilizing of plants, water is sprayed to earth for being absorbed freely. Since the holes of earth have air therein so as to avoid the permeation of water. Most of water can not achieve the roots of plants. If the irrigating area is too large, many labors are necessary. If sprayers are used, although timing is controlled and manpower is saved, the water can not be sprayed according to wetness of earth. The supplying of water is controlled manually, can not be automatically controlled.

### SUMMARY OF THE INVENTION

Accordingly, the primary object of the present invention is to provide an underground root cultivating irrigating device by siphon principle is disclosed. The device is embedded underground. The device comprises a vacuum water tank, a switch, and a water supply tank and other components. The level of inlet water is controlled by the buoyancy of a lifting pontoon. By the punching force of a collision pontoon, the opening and closing of a switch stud so that water may be supplied automatically. By the siphon principle of atmosphere, water supplies to the water supply tank is controlled automatically. Then, according to the wetness of earth, the drainage speed of water is adjusted, so that the irrigating is performed with less power and time.

### BRIEF DESCRIPTION OF FIGURES

Embodiments of the present invention will hereinafter be described, by way of example, with reference to the accompanying drawings, in which:

FIG. 1 is an exploded perspective view of the present invention.

FIG. 2 is an assembled perspective view of the present invention.

FIG. 3 is a cross sectional view of the present invention.

FIG. 4 is a schematic view showing that the switch stud of the present invention is used to seal the water inlet.

FIG. 5 is a schematic view showing the water supply of the present invention.

FIG. 6 is a schematic view showing that the collision pontoon of the present invention drops down.

FIG. 7 is a schematic view showing the collision pontoon of the present invention sealing the water outlet.

FIG. 8 is a schematic view showing the collision pontoon, lifting pontoon, and supporting rod of the present invention adhered to the upper side of the lower magnetic disk.

FIG. 9 is a schematic view showing water begin to input into the present invention.

FIG. 10 is a schematic view showing the collision pontoon of the present invention being floating.

FIG. 11 is a schematic view showing the collision pontoon, lifting pontoon, and supporting rod of the present invention adhered to the lower side of the upper magnetic disk.

FIG. 12 is an exploded perspective view of another embodiment of the present invention.

FIG. 13 is an assembled perspective view of another embodiment of the present invention.

FIG. 14 is an assembled cross sectional view of another embodiment of the present invention.

FIG. 15 shows the application of another embodiment in the present invention.

### DESCRIPTION OF PREFERRED EMBODIMENTS

The present invention is related to a device for supplying water according to the wetness of earth. The level of water is controlled by atmosphere. The water absorption of earth is adjusted automatically. The cost and labor are saved and the irrigating work is performed conveniently and easily.

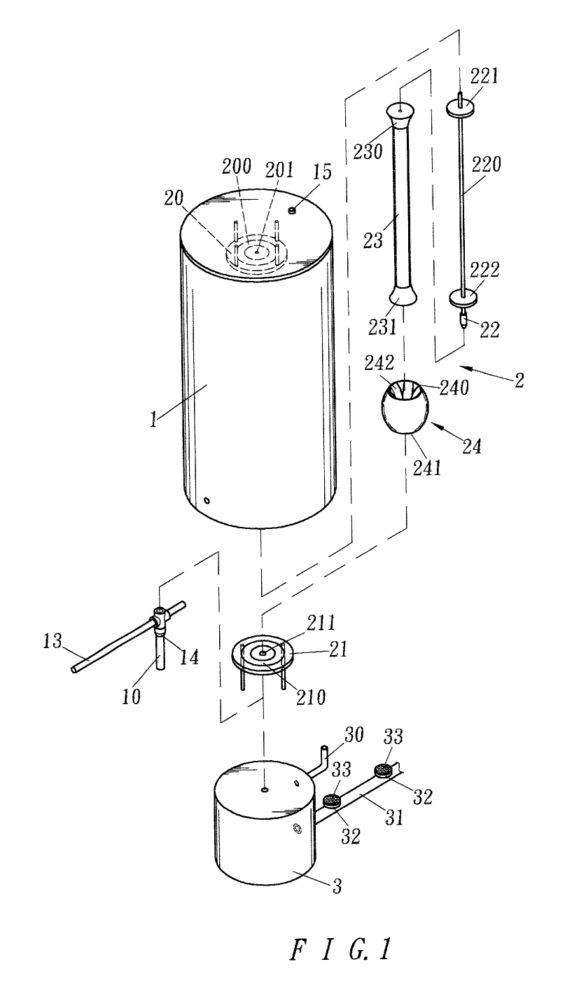

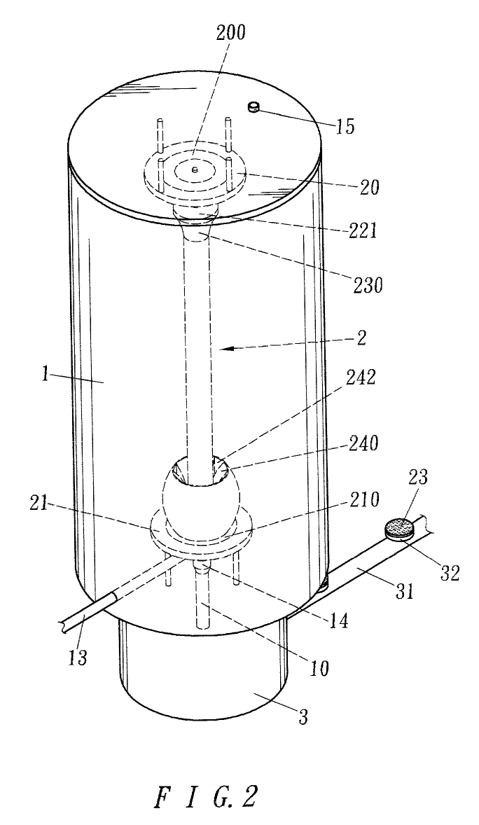

With reference to FIGS. 1, 2 and 3, the present invention has a vacuum water tank 1, a water outlet tube 10 is installed at the bottom of the vacuum water tank 1, and the water outlet tube 10 has a water inlet 11 and a water outlet 12. The water inlet 11 is connected with a water inlet tube 13 which is connected to the water source out of the vacuum water tank 1. The top of the vacuum water tank 1 has a vent 15. A switch 2 is installed in the vacuum water tank 1. The switch 2 has an upper magnetic disk 20, a lower magnetic disk 21, a switch stud 22, a lifting pontoon 23, and a collision pontoon 24. The upper magnetic disk 20 and lower magnetic disk 21 are installed to the top and bottom of the vacuum water tank 1. The upper magnetic disk 20 and lower magnetic disk 21 are circularly installed with magnet 200 and magnet 210 (or electric magnets). The center thereof is installed with through holes 201, 211. The switch stud 22 is installed in the water outlet tube 10 of the vacuum water tank 1. The switch stud 22 has a shape conforming to the taper portion 14 of the water outlet tube 10. The top of the switch 2 is connected to the supporting rod 220. The supporting rod 220 is installed between the through holes 201, 211 of the upper magnetic disk 20 and lower magnetic disk 21 so as to move upwards and downwards. The switch stud 22 may seal the water inlet 11 or water outlet 12 in the water outlet tube 10 so as to control the inlet water or outlet water. The proper positions of the supporting rod 220 are installed with upper stopper 221 and lower stopper 222. The supporting rod 220 can not leave from the confinement of the upper magnetic disk 20 and lower magnetic disk 21. The lifting pontoon 23 is engaged to the outer side of the supporting rod 220 so as to lift or descend freely. The specific weight of the lifting pontoon 23 is about 0.5 and the lifting pontoon 23 has a long strip shape. The upper and lower ends thereof have cambered upper stopper 230 and lower stopper 231, which is made insulated material. The collision pontoon 24 is engaged to the outer side of the lifting pontoon 23 so as to slide upwards and downwards freely. The specific weight of the collision pontoon 24 is about 0.4. The upper and lower ends of the collision pontoon 24 are circularly installed with upper iron blocks 240 and lower iron blocks 241. The cross section of the collision pontoon 24 is like a shuttle and has a stream line shape. The interior thereof is circularly installed with a plurality of flow guiding grooves 242 for reducing the resistance in moving. A water supply tank 3 is installed at the water output of the water outlet tube 10. The bottom of the water supply tank 3 has a proper distance to the water outlet tube 10. The upper side of the water supply tank 3 has a vent tube 30. A plurality of siphons 31 are installed out of the water supply tank 3. A plurality of water permeating device 32 are installed on the siphon 31. Non-weave cloth 33 encloses the water permeating device 32.

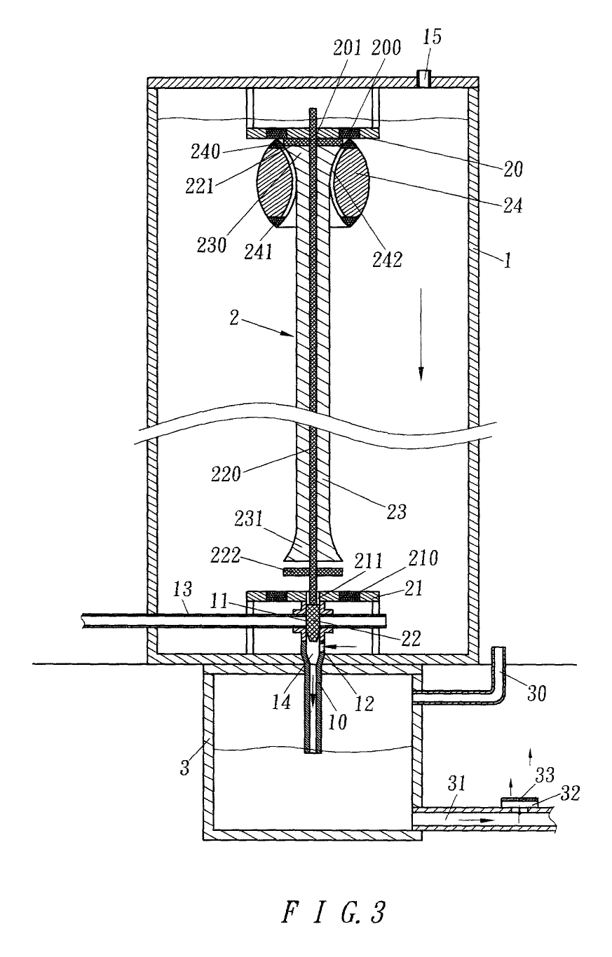

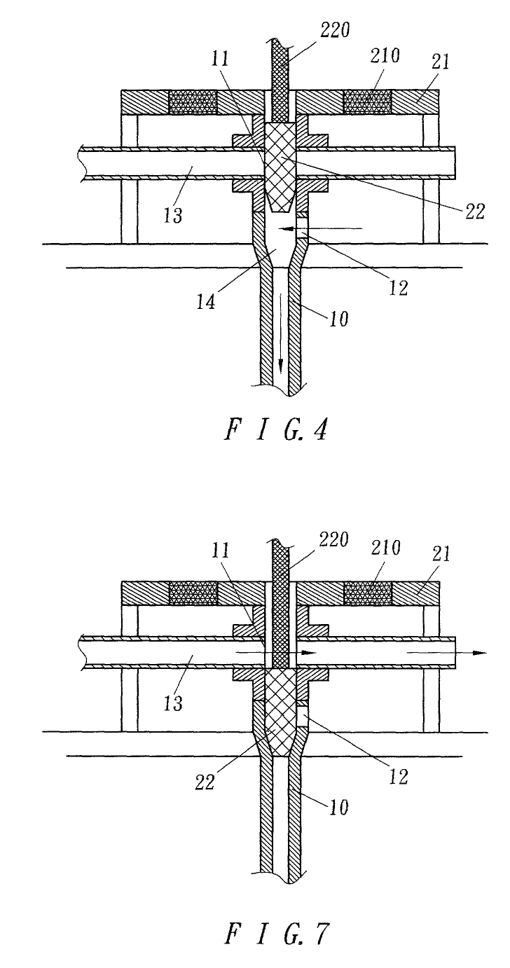

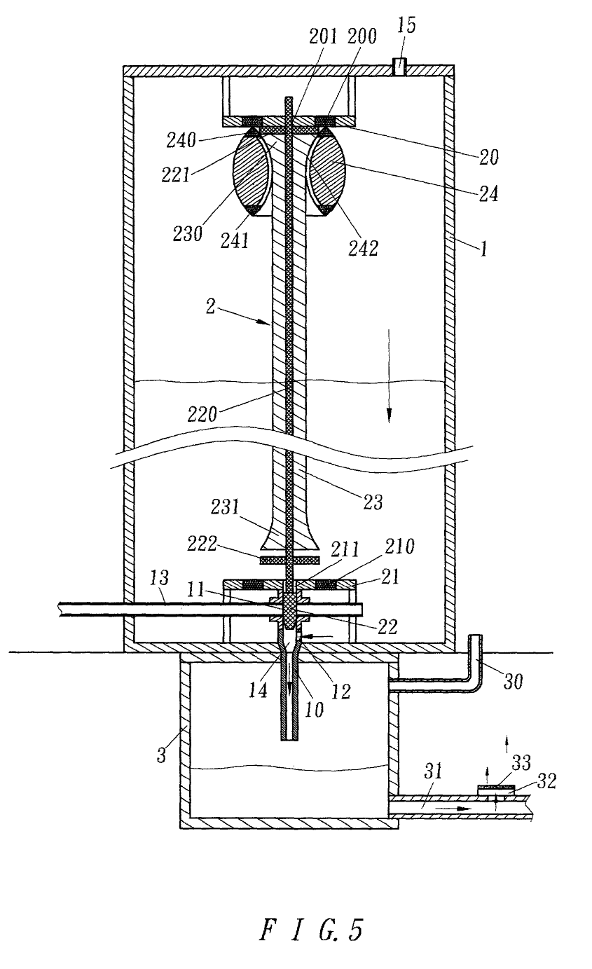

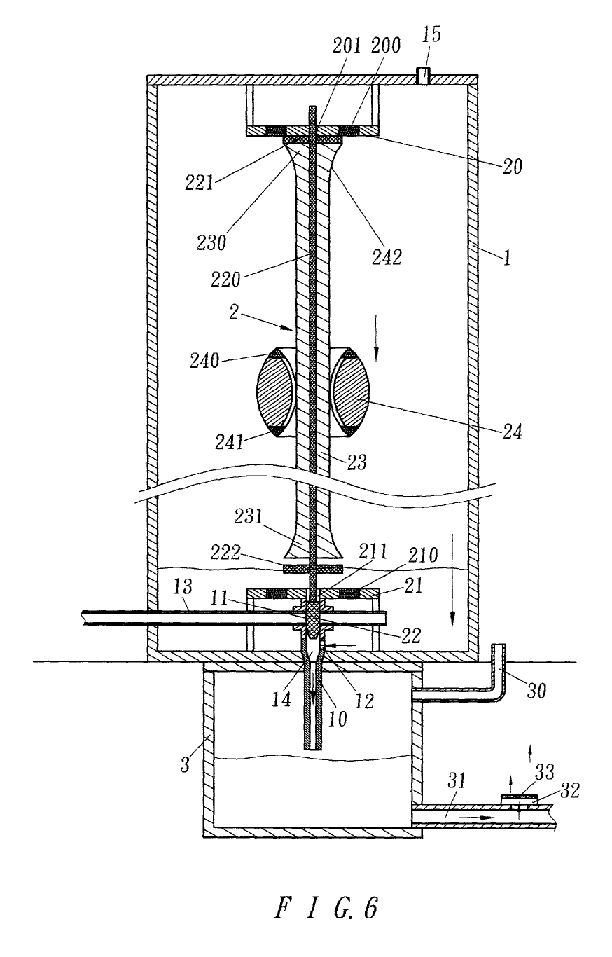

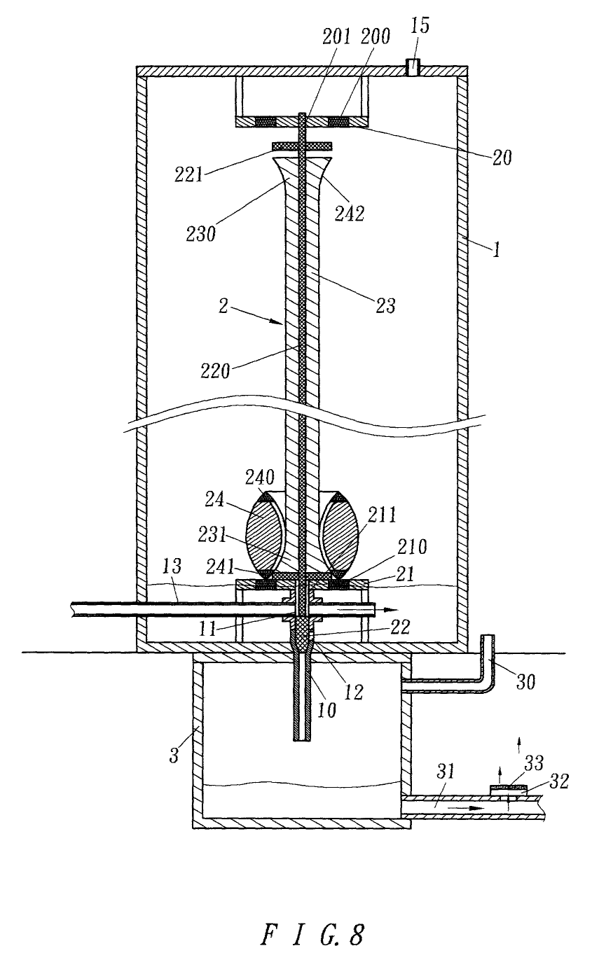

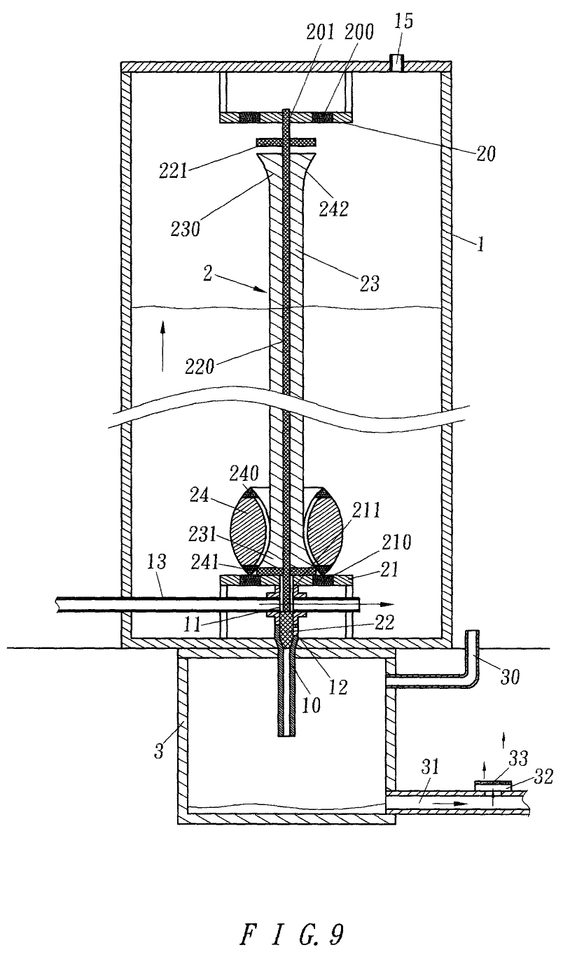

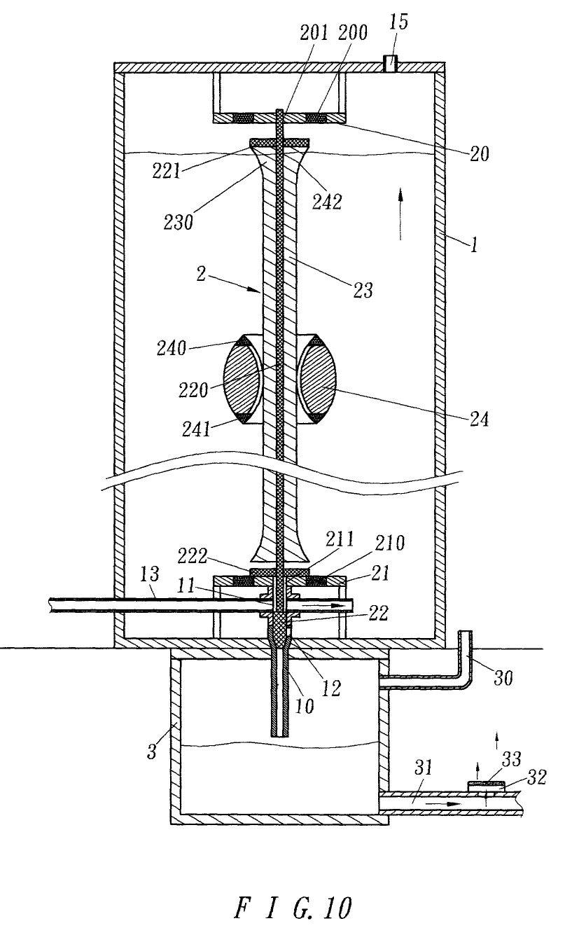

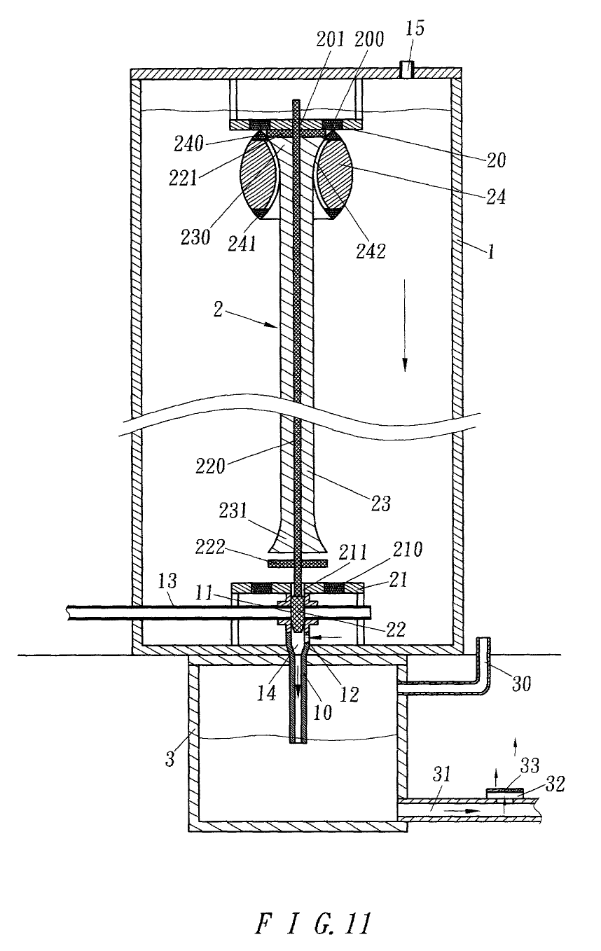

As shown in FIG. 3, the siphons 31 are embedded in the earth so that the water permeating device 32 is at roots of plants. When the water level of the vacuum water tank 1 is full, since the specific weights of the lifting pontoon 23 and collision pontoon 24 are small than water, they must float on the water surface so as to support the upper stopper 221 of the supporting rod 220. The supporting rod 220 moves upwards. When the collision pontoon 24 floats upwards to the upper magnetic disk 20, the upper iron block 240 on the upper magnetic disk 20 will be absorbed by the magnet 200 of the upper magnetic disk 20, while at the same time, the collision pontoon 24 will support against the upper stopper 230 of the lifting pontoon 23 and the upper stopper 221 of the supporting rod 220 so that the collision pontoon 24, lifting pontoon 23, and the supporting rod 220 are adhered to the lower side of the upper magnetic disk 20. When the supporting rod 220 moves upwards, the switch stud 22 moves upwards at the taper portion 14 of the water outlet tube 10 to seal the water inlet 11 (referring to FIG. 4) so that the water will not enter into the vacuum water tank 1 of the water inlet tube 13. Water can enter into the water supply tank 3 through the water outlet tube 10 from the water outlet 12, then flowing into the non-weave cloth 33 out of the siphons 31 for preventing earth from sealing the water permeating device 32. When the soil near the water permeating device 32 is wet, the water will drain out slowly, while when the soil is dry, the water will drain out quickly for supplying the wetness. Therefore, the draining speed of the water is controllable by itself. When the water in the supply tank 3 is reduced gradually, and the level is reduced to be below the distal end of the water outlet tube 10 (referring to FIG. 5), by siphon principle, outer air will flow through the vent 30 to the supply tank 30. Then air flows to the vacuum water tank 1 from the water outlet tube 10 so that the interior pressure is conformable to the exterior pressure. Thus, water is not adjusted by atmosphere and enters into the supply tank 3 from the water outlet tube 10 until level of the tank 3 is higher than the distal end of the water outlet tube 10. Then by siphon principle, water in the water outlet tube 10 will stop flowing out. When the level in the vacuum water tank 1 is lower than the distal of the lifting pontoon 23, then the lifting pontoon 23 will has no function of buoyancy and drop down due to weight itself so that at the same time the collision pontoon 24 will separate from the magnet 200 of the upper magnetic disk 20 and drop down. By the gravitational force, the lower stopper 222 of the supporting rod 220 is collided (referring to FIG. 6) so that the supporting rod 220 moves downwards to drive the switch stud 22 moves downwards in the taper portion 14 of the water outlet tube 10 to seal the water outlet 12 (referring to FIG. 7). Meanwhile, the water inlet 11 is opened, water enters from the water inlet tube 13. When the supporting rod 220 drops to the magnetic disk 21, then the lifting pontoon 23 and collision pontoon 24 drop down, and the lower iron block 241 of the collision pontoon 24 presses against the lower stopper 231 of the lifting pontoon 23 and the lower stopper 222 of the supporting rod 220 so that the collision pontoon 24, lifting pontoon 23, and supporting rod 220 are adhered to the upper sides of the lower magnetic disk 21 (referring to FIG. 8). When water enters, air in the vacuum water tank 1 will vent out from the vent valve 15 (referring to FIG. 9), when level of water is full to a high level (about the upper magnetic disk 20), the collision pontoon 24 will separate from the magnet 210 of the lower magnetic disk 21 (referring to FIG. 10), since the lifting pontoon 23 lose the resisting force of the collision pontoon 24, by the buoyancy itself, it will float upwards. When the collision pontoon 24 floats upwards, the buoyant acceleration will cause it to collide the upper stopper 221 of the supporting rod 220 so that the switch stud 22 out of the taper portion 14 of the water outlet tube 10 to move up, thereby, sealing the water inlet 11 (referring to FIG. 4), and stopping to supply water. Meanwhile, the water outlet 12 outputs water continuously. Furthermore, the upper iron block 240 of the collision pontoon 24 is absorbed by the magnet 200 of the upper magnetic disk 20. The collision pontoon 24 resists against the upper stopper 230 of the lifting pontoon 23 and the upper stopper 221 of the supporting rod 220, so that the collision pontoon 24, lifting pontoon 23, and supporting rod 220 are adhered to the lower side of the upper magnetic disk 20 (referring to FIG. 11). Thus, the operation of entering water is complete until the level of vacuum water tank 1 is again lower than the distal end of the lifting pontoon 23. Then, the collision pontoon 24 will drop down again. The previous action repeats to supply water again, Therefore, by the difference of the lifting pontoon 23, the timings of the highest and lowest are set. The specific weight of the collision pontoon 24 is adjustable and the size of the moving force of the switch stud 22 driving by the supporting rod 220 is set. The specific weights of the lifting pontoon 23 and collision pontoon 24 is adjusted by installing steel balls therein of various sizes and different numbers for generating different specific weight.

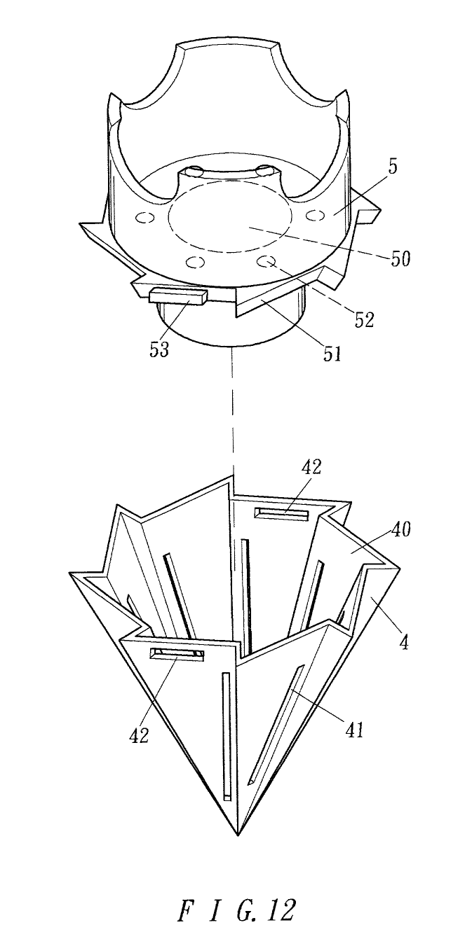

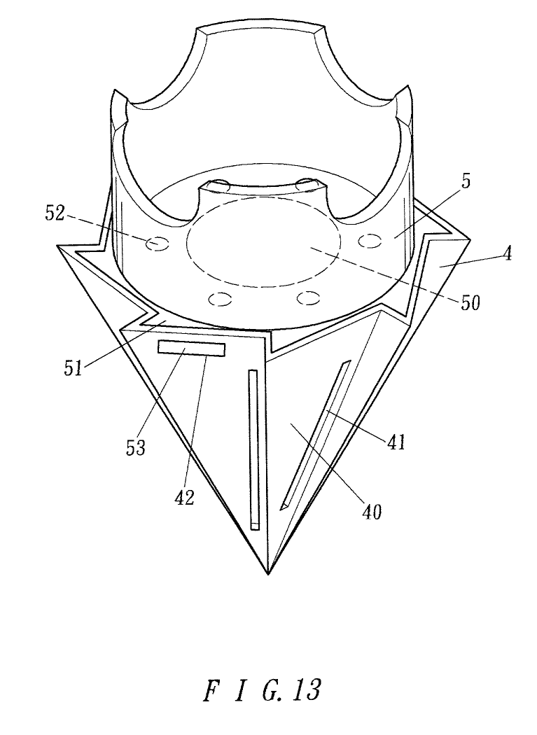

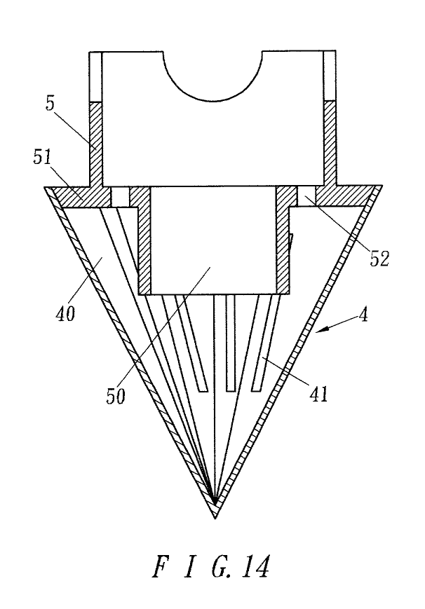

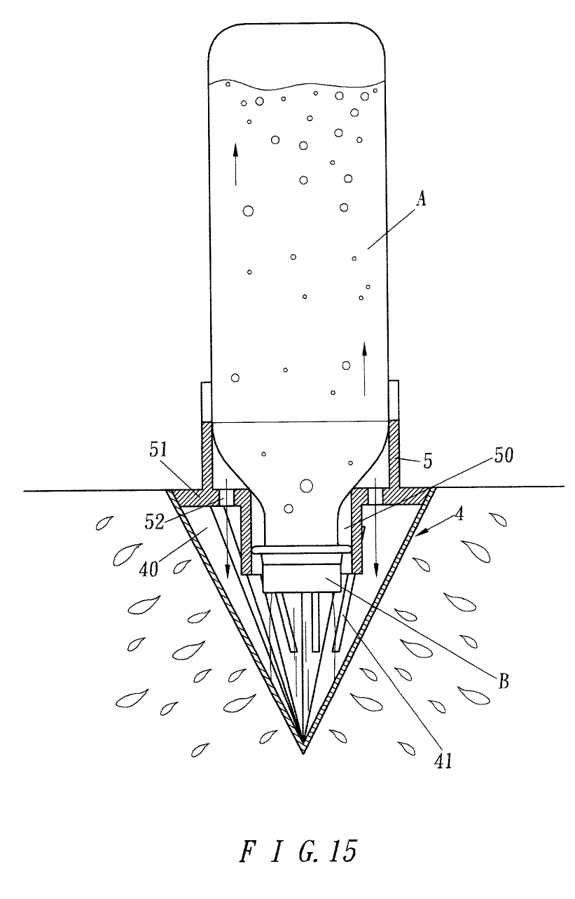

In another embodiment of the present invention, referring to FIG. 12, a home using siphon underground irrigating device is illustrated. A taper base 4 is installed. The base 4 is installed with a plurality of radiated earth stopper 40 which has straight water outlet 41. Two opposite stopper 40 are installed with embedding holes 42. A fixing seat 5 is in the base 4. The seat 5 has fixing hole 50. The periphery of the hole 50 is installed with vents 52. Two opposite stoppers 51 are installed with blocks 53. In assembly, referring to FIGS. 13 and 14, the seat 5 is installed in the base 4 so that the two blocks 53 of the stopper 50 of the seat 5 are embedded into the two holes 42 of the stopper 40 of the base 4. Thus, the seat 5 is tightly engaged with the base 4. The stoppers 50 of the seat 5 are resisted against the stoppers 40 of the base 4 tightly. In using, as shown in FIG. 15, the whole base 4 is embedded into earth, so that only the seat 5 is exposed from the ground and then a plastic bottle A is filled with water and then is placed reversely so that the opening B of the bottle A is inserted into the hole 550 of the seat 5. Thus, the bottle A is steadily placed on the earth. The water in the bottle A flows through the water outlet 41 of the base 4 to the earth. By the stopping effect of the stopper 40, earth will not enter into the base 4 to hinder the drainage of water. When the earth proximate base 4 is wet, water drains out slowly. But when the earth is dry, water drains out quickly to retain water in the bottle A. By the vents 52 of the fixing seat 5, the outer air flows into the base 4. Then it flows into the bottle A. By the siphon principle, the pressures at the interior and interior of the bottles are retained uniformly. The water in the bottle A will be drained out successfully by gravitational force. It is impossible that water can not drain out due to the pressure difference between the interior and exterior of the bottle A. By the engagement of the stoppers 50 of the seat 5 to the stopper 40 of the base 4, earth is prevented from dropping into the base 4 from the seat 5.

The present invention has the following advantages:

1. Water is absorbed by earth, it is prevented that some earth contains too much water so that the interchange of air and water in the root is unbalanced so as to affect the absorption of the nutrition.

2. Water is supplied by siphon principle, thus drainage of water is adjusted from the wetness of water. Power and time are saved.

3. The root is cultivated biologically and automatically The present invention is embedded in earth so that the nutrition can be permeated into earth to achieve the root of the plant.

4. The irrigating device of the present invention may be used in the cultivation of plant at home. Water is supplied properly. The water is stored by bottle which can be acquired easily. The waste is used sufficiently and therefore, cost is saved.

It will also be appreciated that other modifications and variations may be made to the embodiments as described and illustrated within the scope of the present application as defined in the following claims.

I claim:

1. An underground root cultivating irrigating device by siphon principle comprising:
a vacuum water tank, a water outlet tube being at a bottom of the vacuum water tank, the water outlet tube having a water inlet and a water outlet; the water inlet being connected with a water inlet tube which is connected to a water source out of the vacuum water tank; a taper portion being formed between the water inlet and water outlet; a top of the vacuum water tank having a vent;
a switch being installed in the vacuum water tank; the switch having an upper magnetic disk, a lower magnetic disk, a switch stud, a lifting pontoon, and a collision pontoon; the upper magnetic disk and lower magnetic disk are installed to a top and a bottom of the vacuum water tank; both of the upper magnetic disk and lower magnetic disk being circularly installed with magnet, and a center thereof is installed with through holes; the switch stud being installed in the water outlet tube of the vacuum water tank; the switch stud having a shape conforming to the taper portion of the water outlet tube; a top of the switch being connected to the supporting rod; the supporting rod being installed between the through holes of the upper magnetic disk and lower magnetic disk so as to move upwards and downwards; the supporting rod being installed with upper stopper and lower stopper; the lifting pontoon being installed at an outer side of the supporting rod; an upper and a lower end thereof being installed with an upper stopper and a lower stopper; the collision pontoon being engaged to an outer side of the lifting pontoon and an upper and a lower end thereof being installed with an upper iron block and an lower iron block, while the interior thereof being installed with a plurality of flow guide grooves.
a water supply tank being installed at the water output of the water outlet tube; a bottom of the water supply tank having a proper distance to the water outlet tube; an upper side of the water supply tank having a vent tube; a plurality of siphons being installed out of the water supply tank; a plurality of water permeating device being installed on the siphon; and non-weave cloth encloses the water permeating device.

2. The underground root cultivating irrigating device by siphon principle as claimed in claim 1, wherein the specific weight of the lifting pontoon is about 0.5 and the specific weight of the collision pontoon is about 0.4; a cross section of the collision pontoon is a shuttle and has a stream line shape; and interiors of the collision pontoon and lifting pontoon are embedded with steel balls for adjusting the specific weight.

3. The underground root cultivating irrigating device by siphon principle, wherein a base is installed, a plurality of earth stoppers are installed on the base; each earth stopper are installed with water outlet; each earth stopper is formed with holes; a fixing seat is in the base; a seat has fixing hole; a periphery of the hole is installed with vents; the stoppers are installed with blocks.

4. The underground root cultivating irrigating device by siphon principle as claimed in claim 3, wherein the earth stoppers are arranged in a radiating pattern.

5. The underground root cultivating irrigating device by siphon principle as claimed in claim 3, wherein a plurality of straight water outlets are formed on the earth stopper.
